(19) United States
(12) Patent Application Publication
(10) Pub. No.: US 2012/0213397 A1
(43) Pub. Date: Aug. 23, 2012

(54) Portable Speaker Apparatus

(76) Inventor: Randel L. Crotts, Hermitage, TN (US)

(21) Appl. No.: 13/032,015

(22) Filed: Feb. 22, 2011

(51) Int. Cl. H04R 1/02

(52) U.S. Cl. 381/334

(57) ABSTRACT

A portable speaker apparatus includes a casing defining an interior area. A processor and memory are situated in the casing, the memory having program instructions, prerecorded sound data records, and auxiliary sound data records. A sound data input is connected to the processor and memory for transferring auxiliary sound data to respective memory records, such as sound data from a computer or mp3 player. A sound selection input is connected to the processor and memory for selecting one of a respective prerecorded sound record and auxiliary sound record. A microphone is configured to receive sound from outside the casing. A speaker is situated in the casing and configured to emit selected sound data received immediately from the microphone and to emit sound data selected from memory.

### BACKGROUND OF THE INVENTION

This invention relates generally to personal electronic audio devices and, more particularly, to a portable speaker apparatus that amplifies a user's voice and emits predetermined sound data and other sound data uploaded by a user. The portable speaker apparatus enables a user to play amplified sounds specific to fans cheering for their favorite sports team.

Fans of a sports team, such as a high school, college, or professional athletic team, enjoy cheering, applauding, yelling cheers, booing, or otherwise making noise. Athletic teams may also have a fight song or other melodies that are played by a band or speakers. A team whose fans make a high level of noise may even have a competitive advantage over their opponents when playing at their home stadium or arena.

Various devices have been proposed in the art for amplifying a fan's cheering, such as a traditional megaphone. Other devices have been proposed for playing music and other prerecorded sounds, such as devices for use for karaoke. Although assumably effective for their intended purposes, the existing devices do not provide a portable speaker system for amplifying a user's own voice, having a plurality of prerecorded sounds, a plurality of additional sound data uploaded from external data sources, and the capability of combining stored sound data with a user's amplified voice.

Therefore, it would be desirable to have a portable speaker apparatus that satisfies all of the limitations of existing or past devices and proposals.

### SUMMARY OF THE INVENTION

A portable speaker apparatus according to a preferred embodiment of the present invention includes a casing defining an interior area. A processor and memory are situated in the casing, the memory having program instructions, prerecorded sound data records, and auxiliary sound data records. A sound data input is connected to the processor and memory for transferring auxiliary sound data to respective memory records, such as sound data from a computer or mp3 player. A sound selection input is connected to the processor and memory for selecting one of a respective prerecorded sound record and auxiliary sound record. A microphone is configured to receive sound from outside the casing. A speaker is situated in the casing and configured to emit selected sound data received immediately from the microphone and to emit sound data selected from memory.

Therefore, a general object of this invention is to provide a portable speaker apparatus that provides sports fans a way to amplify typical “crowd noise” while watching a sporting event.

Another object of this invention is to provide a portable speaker apparatus, as aforesaid, in a portable casing with selection buttons with which a user may select from prerecorded sounds such as cheering, booing, whistling, and the like.

Still another object of this invention is to provide a portable speaker apparatus, as aforesaid, that enables a user to upload sound data such as school fight songs or other sound effects and then select from such auxiliary sound data to be amplified on demand.

Yet another object of this invention is to provide a portable speaker apparatus, as aforesaid, having a microphone that enables a user's voice to be amplified even while a selected prerecorded or auxiliary sound record is being emitted.

A further object of this invention is to provide a portable speaker apparatus, as aforesaid, to which an mp3 player may be connected and sound data therefrom amplified.

A still further object of this invention is to provide a portable speaker apparatus, as aforesaid, that may connect to other identical apparatuses wirelessly for enhanced amplification.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a portable speaker apparatus according to a preferred embodiment of the present invention;

FIG. 2 is an exploded view of the apparatus as in FIG. 1;

FIG. 3a is a top view of the apparatus as in FIG. 1;

FIG. 3b is a right side view of the apparatus as in FIG. 1;

FIG. 3c is a left side view of the apparatus as in FIG. 1;

FIG. 4 is a front side view of the apparatus as in FIG. 1 with the front face removed; and

FIG. 5 is a block diagram illustrating the electrical components of the present invention.

### DESCRIPTION OF THE PREFERRED EMBODIMENT

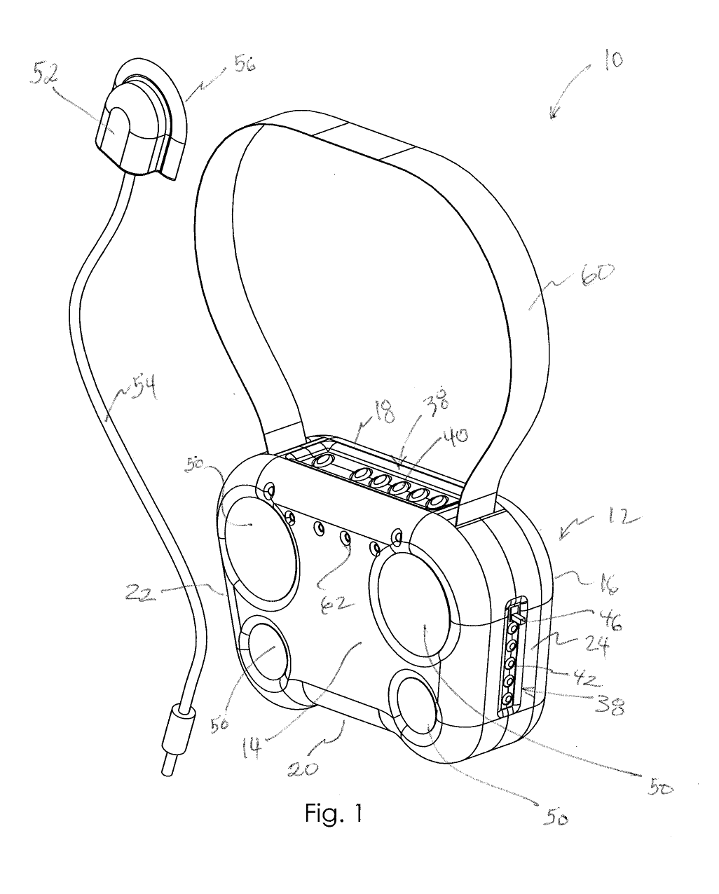

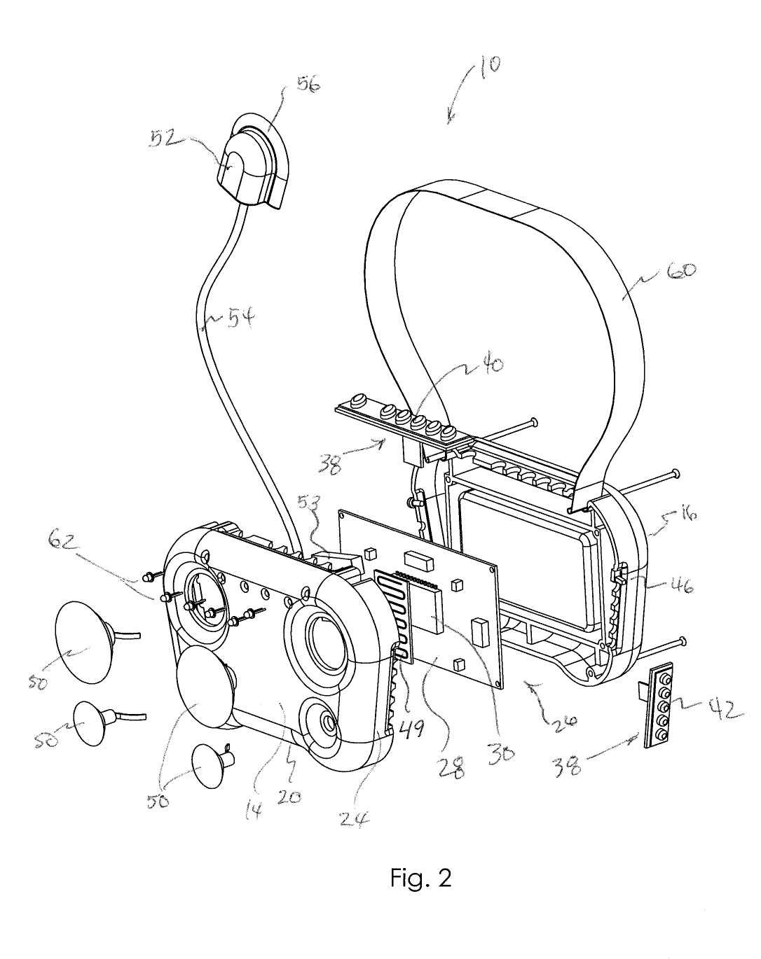

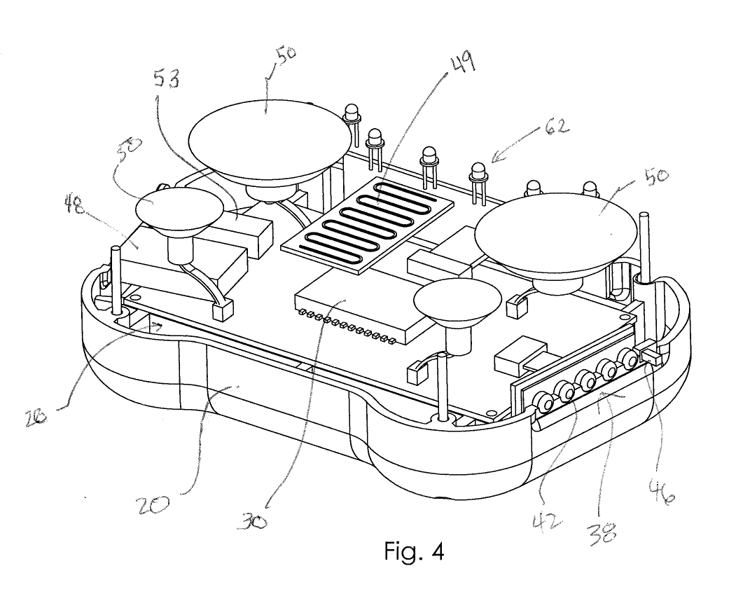

A portable speaker apparatus according to a preferred embodiment of the present invention will now be described with reference to FIGS. 1 to 5 of the accompanying drawings. The portable speaker apparatus 10 includes a processor 30, memory 32, microphone 52, and at least one speaker 50 situated on or inside a casing 12.

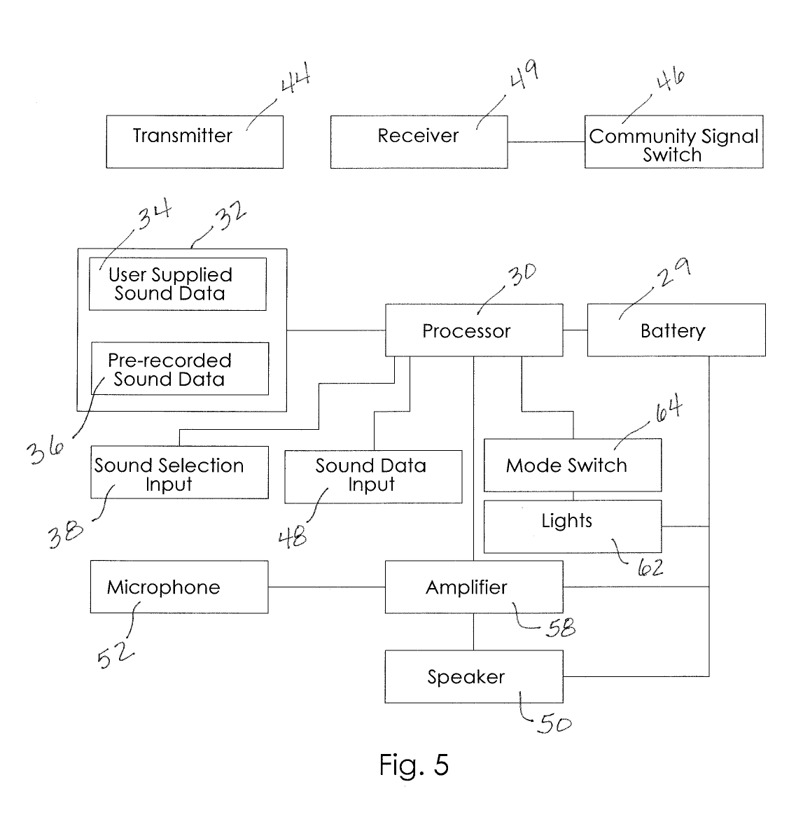

The portable speaker apparatus 10 includes a casing 12 having front 14 and rear 16 faces connected by top 18, bottom 20, and left 22 and right 24 side walls that together define an interior area 26. Electronic components are positioned in the interior area 26 of the casing 12 as will be more particularly described below. The electronic components may be mounted on a printed circuit board (“PCB”) 28. A battery 29 may be positioned within the casing interior space and electrically connected to the electronic components as shown in FIG. 5. Specifically, a processor 30 and memory 32 are situated in the casing interior area 26. The memory 32 stores a plurality of program instructions for execution by the processor 30 as will be described later. Further, the memory 32 includes data structures in the form of records as will be understood by one of ordinary skill in the art of computer programming and data processing. Even more particularly, the memory 32 includes a plurality of prerecorded sound data records 34 and auxiliary sound data records 36 (FIG. 5). The prerecorded sound data records 34 may include sound data in the form of cheering, whistling, booing, school spirit yelling, generic fight songs, and the like. The auxiliary sound data records 36 are configured to receive non-prerecorded sound files that may be uploaded by a user under processor control.

The portable speaker apparatus 10 includes at least one sound data input 48 electrically connected to the processor 30 by which a user may upload auxiliary sound data, such as from a computer, mp3 player, or the like. The sound data input 48 may be a USB port, audio jack, or the like, that provides a data connection between the external data device and the processor 30. The processor 30, using program instructions stored in memory 32, causes sound data received from the external data device to be stored in respective auxiliary sound data records 36 which can then be accessed later using data selection means described below. Alternatively, the portable speaker apparatus 10 may include a receiver 49, such as an antenna, configured to receive sound data wirelessly, such as from a wireless computer network.

The portable speaker apparatus 10 also includes at least one sound selection input 38 to enable a user to select a desired sound data record. More particularly, a plurality of prerecorded sound selector buttons 40 may be situated on a top wall 18 of the casing 12, each button being electrically connected to the processor 30 and associated with a respective prerecorded sound data record 34. It is understood that in other embodiments (not shown), a single prerecorded sound selector button may be included and used to cycle through the available prerecorded sounds and for selecting a desired prerecorded sound. In such an embodiment, a display may be included to visually indicate available prerecorded sounds and to make selection convenient. Similarly, a plurality of auxiliary sound data selector buttons 42 may be positioned on a right side wall 24 of the casing 12 and electrically connected to the processor 30. Each auxiliary sound selector button 42 may be associated with a respective auxiliary sound data record 36. In other embodiments (not shown), a single auxiliary sound selector button may be included. It is understood that program instructions executable by the processor 30 may be stored in memory 32 for managing operation of selecting a prerecorded or auxiliary sound data record.

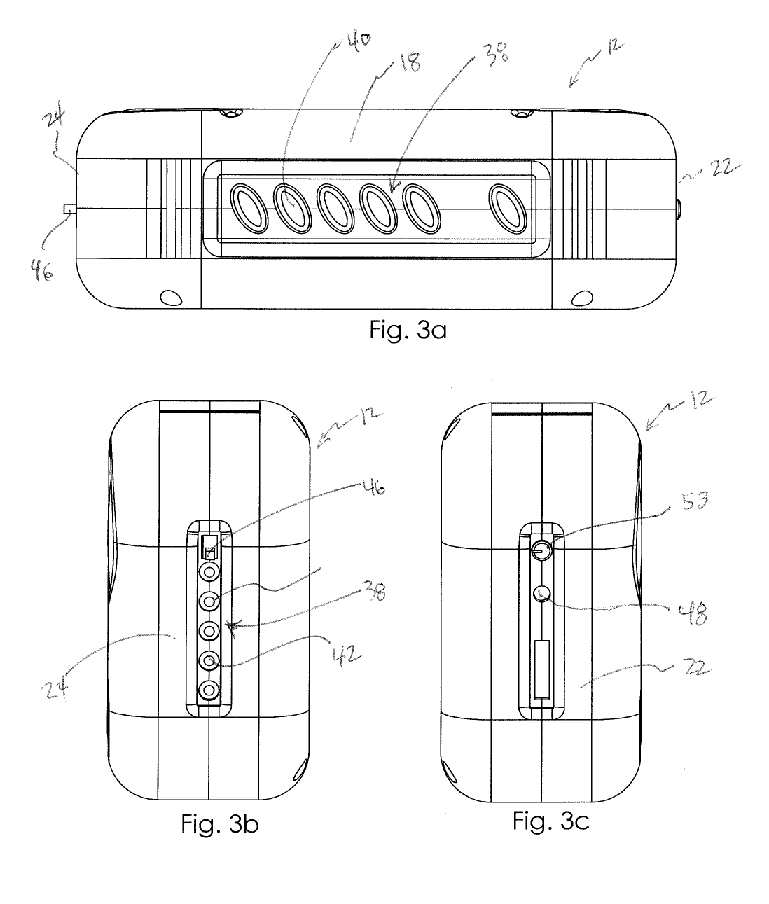

The speaker 50 may be positioned on the front face 14 of the casing 12 and electrically connected to the processor 30. It is understood that the speaker 50 may be a single speaker or multiple speakers of different sizes and types. Preferably, the microphone 52 is tethered to the casing 12 with a data cable 54 that is electrically connected to the speaker 50. The casing 12 may include an audio jack 53 for connecting the data cable 54 to the circuit board 28 (FIG. 3c). The microphone 52 may include a fastener 56 or other means for being attached to an article of clothing. In some embodiments, the microphone 52 may be fixedly attached to the casing 12. Sound received by the microphone 52 may be emitted immediately by the speaker 50. Further, an amplifier 58 may be positioned intermediate the microphone 52 and a speaker 50 so as to increase the volume of sound from the microphone 52 before being emitted by the speaker 50. The amplifier 58 is also intermediate the processor 30 and speaker 50 for amplifying prerecorded and auxiliary sound data records before being emitted from the speaker 50.

A handle 60, such as a lanyard, may be operatively coupled to the casing 12 so that the casing 12 may be portable. In other words, the handle 60 enables the casing 12 to be carried by hand, placed around a user's neck, or the like.

In some embodiments, a plurality of light members 62 may be positioned on an exterior surface of the casing 12 and electrically connected to the battery 29. In some embodiments, a mode selection switch 64 may be electrically connected to the light members 62 (FIG. 5) and processor 30 for selecting or cycling the plurality of light members 62 between a plurality of light activation modes/lighting patterns.

In another aspect of the invention, the portable speaker apparatus 10 may include a transmitter 44 and a receiver 49 situated in the casing interior area 26 and in data communication with the processor 30. It is understood that the receiver 49 may be the same receiver 49 as described above for use as a sound data input 48. The apparatus 10 may also include an activation switch 46 in communication with the processor 30. As will be described below, the transmitter 44, receiver 49, and activation switch 46 enable more than one portable speaker apparatus to communicate sound data to and from one another so as to emit the same sound data simultaneously.

More particularly, the apparatus 10 includes programming causing the processor 30 to determine if the activation switch 46 has been actuated and, if so, to activate the transmitter 44 to transmit sound data received by the microphone 52 into the air. For instance, if a user actuates the activation switch 46, then any subsequent sounds received through the microphone 52 would be immediately emitted through the speaker 50 but also broadcast via the transmitter 44 into the air to be received by another respective portable speaker apparatus 10. In addition, programming may cause a respective sound record to be transmitted, such as a previously selected prerecorded or auxiliary sound record.

Similarly, the apparatus 10 includes programming such that the processor 30 may determine if the activation switch 46 has been actuated and, if so, to energize the receiver 49 to receive sound data from another portable speaker apparatus 10. If sound data is received by the receiver 49, the speaker is activated to emit the sound data. In some embodiments, there may be one activation switch dedicated to activating the transmitter 44 to transmit sound data into the airwaves and another activation switch dedicated to activating the receiver 49 to receive sound data from another apparatus 10. Accordingly, the transmitter 44 and receiver 49 enable multiple portable speaker apparatuses to cooperatively amplify selected sounds while observing a sporting event.

In use, a user may upload selected sound data to the portable speaker system as described above, such as by connecting the device to a computer, by connecting to an mp3 player, by wireless connection with a computer network, or the like. A user may attach the microphone 52 to an article of clothing, such as a shirt, and sing or speak into it, the sound being immediately amplified and emitted through the speaker 50. In addition, a user may select prerecorded or auxiliary sound data records using the sound selection input(s), the sound data records being emitted through the speaker 50. It is understood that a user may speak or sing into the microphone 52 and have the sound emitted through the speaker 50 while another sound data record is being emitted.

It is understood that while certain forms of this invention have been illustrated and described, it is not limited thereto except insofar as such limitations are included in the following claims and allowable functional equivalents thereof.

1. A portable speaker apparatus, comprising:
a casing defining an interior area;
a processor situated in said casing interior area;
a memory situated in said casing interior area and in data communication with said processor, said memory having:
a plurality of program instructions for execution by said processor;
a plurality of prerecorded sound data records;
a plurality of sound data records for storing auxiliary sound data;
a sound data input situated in said casing interior area and electrically connected to said memory and to said processor, said sound data input being configured to transfer auxiliary sound data from a data source outside said casing to a respective sound data record in said memory;
a sound selection input electrically connected to said memory and to said processor configured to select one of a respective prerecorded sound data record and a respective auxiliary sound data record;
a microphone configured to receive sound from outside said casing;
a speaker electrically connected to said processor and to said microphone, said speaker configured to emit sound immediately upon receipt by said microphone;
programming causing said processor to:
determine if new auxiliary sound data is received by said sound data input;
store said received auxiliary sound data in a respective sound data record in said memory if said new auxiliary sound data has been received by said so and data input;
determine if one of a respective auxiliary sound data record and a respective prerecorded sound data record has been selected by said sound selection input; and
energize said speaker to emit said selected sound data record.

2. The portable speaker apparatus as in claim 1, further comprising an amplifier positioned in said interior area of said casing and interconnected between said microphone and said speaker, said amplifier being configured to increase the volume of audio data received thereby.

3. The portable speaker apparatus as in claim 2, wherein said amplifier is electrically connected to said processor and said speaker, said amplifier configured to increase the volume of sound data received thereby.

4. The portable speaker apparatus as in claim 1, wherein said sound data input is a USB port.

5. The portable speaker apparatus as in claim 4, wherein said sound selection input is a plurality of pre-recorded sound selector buttons positioned on an exterior of said casing, each of said plurality of selector buttons being electrically connected to said processor.

6. The portable speaker apparatus as in claim 4, wherein said sound selection input is a plurality of auxiliary sound selector buttons positioned on an exterior of said casing, each of said plurality of auxiliary sound selector buttons being electrically connected to said processor.

7. The portable speaker apparatus as in claim 1, wherein said microphone includes means for attachment to an article of clothing.

8. The portable speaker apparatus as in claim 1 wherein said sound data input is an antenna positioned in said interior area and electrically connected to said processor, said antenna configured to receive sound data signals from an internet wireless network for storage in said memory.

9. The portable speaker apparatus as in claim 1, further comprising a handle coupled to said casing by which said casing is portable.

10. The portable speaker apparatus as in claim 1, further comprising:
a battery positioned in said casing interior area and electrically connected to said processor;
a plurality of light members situated on an outer surface of said casing and electrically connected to said battery.

11. The portable speaker apparatus as in claim 10, further comprising a mode selection switch positioned on said casing and electrically connected to said processor and to said plurality of light members, said mode switch configured to cycle said plurality of light members between a plurality of predetermined light activation modes.

12. The portable speaker apparatus as in claim 10, wherein said speaker is a plurality of speakers spaced apart from one another on an outer surface of said casing.

13. The portable speaker apparatus as in claim 1, further comprising:
a transmitter positioned in said casing interior space and electrically connected to said processor;
a receiver positioned in said casing interior space and electrically connected to said processor;
an activation switch electrically connected to said processor;
programming causing said processor to:
determine if said activation switch has been actuated; and
actuate said transmitter to transmit one of sound input from said microphone and a previously selected sound data record into the air if said activation switch has been actuated.

14. The portable speaker apparatus as in claim 13, further comprising programming causing said processor to:
determine if said activation switch has been actuated;
actuate said receiver to receive respective sound data; and
actuate said speaker to emit said received sound data.

15. The portable speaker apparatus as in claim 1, wherein said sound data input is an external music player port configured to connect to an external mp3 player.
